(19) United States
(12) Patent Application Publication
(10) Pub. No.: US 2004/0016173 A1
(43) Pub. Date: Jan. 29, 2004

(54) Electronic insect trap with black housing

(76) Inventors: Clay E. Tully, Hummelstown, PA (US); Nathan Ehresman, Mt. Joy, PA (US)

Correspondence Address: JACOBSON HOLMAN PLLC, 400 SEVENTH STREET N.W., SUITE 600, WASHINGTON, DC, 20004, US

(21) Appl. No.: 10/206,061

(22) Filed: Jul. 29, 2002

(51) Int. Cl. A01M 1/14

(52) U.S. Cl. 43/114

(57) ABSTRACT

The use of a black housing in an electronic trap utilizing light to attract flies to an access opening in the housing with disposable glue or adhesive fly paper sheets overlying the light source in the housing has been shown to attract and capture many multiples of targeted insects, particularly in a fully lighted room, when compared to a fly trap with a white housing.

### BACKGROUND OF THE INVENTION

1. Field of the Invention

This invention relates to a electronic fly traps, and more particularly to devices utilizing light to attract flies to an access opening in an enclosure or housing carrying the light source, with disposable glue or adhesive fly paper overlying the light source within the housing to capture the flies.

2. Prior Art

Numerous designs of electronic fly traps arc commercial available, some of which utilize visible light to attract flying insects such as flies, or the like into an enclosure where they are entrapped on a sticky surface as they approach a light source located beneath a disposable sheet having an adhesive surface similar to the well known fly paper or glue boards found in many other insect and rodent traps. Exemplary include U.S. Pat. Nos. 5,974,727 and 5,950,355 (Gilbert), U.S. Pat. No. 5,651,211 (Regan et al.), U.S. Pat. No. 5,425,197 (Smith), U.S. Pat. No. 4,117,624 (Phillips) and U.S. Pat. No. 4,074,457 (Sato et al.). More recent developments in this art have been made by Brown et al. as shown in U.S. Pat. No. 6,393,759 issued May 28, 2002 (the '759 patent) and U.S. Pat. No. 6,397,515 issued Jun. 4, 2002 (the '515 patent). The disclosures of all of the foregoing patents are incorporated herein in their entireties by reference.

Of particular interest is the '759 patent which is directed to an electronic fly trap apparatus comprising a housing including a base and cover together defining an interior chamber with at least one flying insect access aperture extending through a portion of the cover. Typically, the housing is formed of a white or very light color polymer. A light is positioned in the base and a disposable sheet having a plurality of apertures therethrough and a sticky adhesive on its upper surface is positioned above the source of light. Light and heat pass through the apertures and the adhesive in the disposable sheet into a spaced provided beneath the cover with a reflective panel placed beneath the light to redirect primary light through the apertures. Flying insects pass into the apparatus through the access aperture and are entrapped on the sticky adhesive of the disposable sheet when they seek the source of the light.

This Brown et al. trap apparatus is efficient and attractive, may be wall mounted or placed on a suitable horizontal surface, such as a table or counter top, and is easy to maintain and clean. It has been found, however, that, particularly when the trap is operated in a fully lighted room, the number of insects captured is significantly reduced.

### SUMMARY OF THE INVENTION

It is a primary object of this invention to provide an improved electronic flying insect trap apparatus, particularly one enabling high levels of captured targeted insects even in a fully lighted room.

Consistent with the foregoing objective, the instant invention is designed to incorporate an additional means to attract flying insects to the trap, particularly flies, that would not be attracted to the light source in the housing of the electronic fly trap apparatus either because of their initial distance from the trap or because the light source tends to blend into the ambient light as a result of the indistinguishable nature of the trap housing.

Other and further objects of this invention will be readily understood by those with ordinary skill in the art with particular reference to the following detailed description of the preferred embodiments in combination with the accompanying drawing.

### BRIEF DESCRIPTION OF THE DRAWING

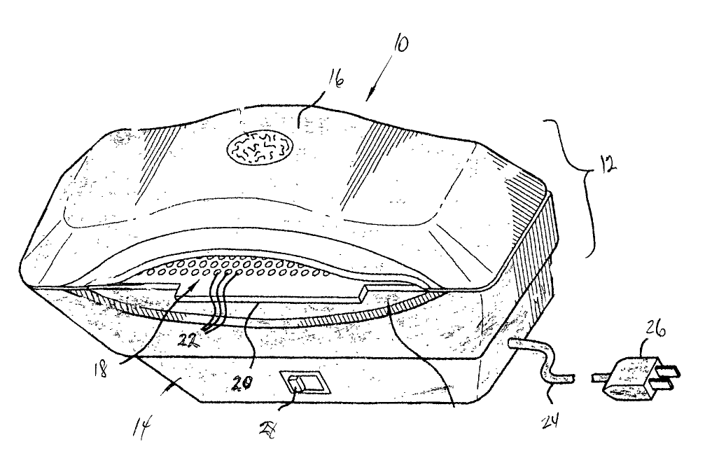

The sole FIGURE corresponds generally to FIG. 1 of the '759 patent and is a perspective view of one form of electronic fly trap apparatus that can effectively incorporate the instant inventive concepts.

### DETAILED DESCRIPTION OF THE PREFERRED EMBODIMENTS

An electronic fly trap apparatus of the type seen in the '759 patent is designated generally by the reference numeral 10 and comprises a housing 12, including a base 14 and a cover 16 which may be secured to each other by any known means, such as glue, light, heat or vibration bonding, fasteners, snap-together fastening, etc. An access aperture 18 is provided between the base 14 and the cover 16 and a disposable, adhesively-covered sheet 22, preferably with a plurality of apertures 24, is slidably received through the access opening 18 and removably retained between the base 14 and the cover 16.

A light source, such as one or more fluorescent lights (not shown,) is positioned within the base 14 and empowered by the electric wire 24 and plug 26 through a control switch 28 in an obvious manner. Further details of an electronic fly trap apparatus of this type will be seen in the aforementioned Brown et al. patents, and are not critical to the instant inventive concepts which are believed to be useful in association with the Brown et al. structure, as well as other electric or electronic flying insect trap devices.

The operation of an apparatus of this type is relatively simple, although design sophistication enhancements disclosed, for example, in the Brown et al. patents, improve the effectiveness of the trap. Basically, however, the light and heat emanating from the light source passes through the sheet 22 and the adhesive coating and illuminates the access aperture 18 to attract flies or other flying insects to the trap 10. When they enter the space below the cover 16 to seek the source of the light, they are trapped by the adhesive material on the sheet 18.

As mentioned above, while devices of this type are attractive and effective, they have been found to have limited ability to attract and capture flies, particularly in a fully lighted room. The housing 12 in prior art traps of this nature known to applicant has been either white or a very light color, and it is believed that the effectiveness of the light in attracting flies and the like to the trap 10 in a fully lighted room is greatly diminished by the limited distinctiveness between the trap light and the ambient light which merge through the white housing, particularly when viewed by flying insects at a distance from the trap 10 itself

It has now been discovered that the effectiveness of an electronic fly trap apparatus of this type can be unexpectedly and surprisingly enhanced by simply changing the color of the housing. Specifically, a black housing dramatically increases the catch, particularly in a fully lighted room. Although not willing to be bound by theory, it is believed that the black housing will act as an initial target for the flies which are attracted to this color and, then, when they get close enough to the trap, the light and heat emanating from within the trap acts as a bulls eye to draw them into the access aperture for capture by the adhesive on the glue board or fly paper element.

Although, for all practical purposes, the entire exterior of the housing will normally be substantially black, it is to be understood that the instant inventive concepts will likely be effective in attracting flies and the like even if only portions of the trap housing, such as the area surrounding the access opening, are black.

In any event, the unexpectedly improved capture rate resulting from the use of a black housing according to this invention has been confirmed by tests comparing identical trap apparatuses having a white housing, as in the prior art, and having a black housing according to this invention. The trap with the black housing consistently captured many multiples of flies compared with the trap with the white housing in a fully lighted room, while, in a darkened room, the catch is fairly consistent regardless of the housing color.

Tables 1, 2 and 3 show separate tests conducted on different days in a fully lighted room, and Table 4 shows an average of the results of those test:

TABLE I
Fully Lighted Room

| | | |
|---|---|---|
| Start Irradiance | 440.40 | 435.50 |
| End Irradiance | 435.00 | 432.00 |

| Hour | Catches Black Unit | Catches White Unit |
|---|---|---|
| 0:00 | 0 | 0 |
| 1:00 | 8 | 1 |
| 2:00 | 15 | 2 |
| 3:00 | 18 | 2 |
| 4:00 | 22 | 2 |
| 5:00 | 25 | 2 |
| 6.00 | 25 | 2 |
| 7.00 | 25 | 2 |
| 8.00 | 25 | 2 |
| TOTAL | 25 | 2 |

TABLE 2
Fully Lighted Room

| | | |
|---|---|---|
| Start Irradiancc | 425.50 | 425.00 |
| End Irradiance | 430.00 | 428.00 |

| Hour | Catches Black Unit | Catches White Unit |
|---|---|---|
| 0:00 | 0 | 0 |
| 1:00 | 7 | 1 |
| 2:00 | 12 | 2 |
| 3:00 | 16 | 3 |
| 4:00 | 18 | 4 |
| 5:00 | 20 | 4 |
| 6:00 | 23 | 4 |
| 7:00 | 23 | 5 |
| 8:00 | 23 | 5 |
| TOTAL | 23 | 5 |

TABLE 3
Fully Lighted Room

| | | |
|---|---|---|
| Start Irradiance | 438.00 | 433.00 |
| End Irradiance | 436.00 | 420.00 |

| Hour | Catches Black Unit | Catches White Unit |
|---|---|---|
| 0:00 | 0 | 0 |
| 1:00 | 4 | 1 |
| 2:00 | 7 | 2 |
| 3:00 | 8 | 3 |
| 4:00 | 10 | 3 |
| 5:00 | 12 | 3 |
| 6:00 | 17 | 3 |
| 7:00 | 20 | 3 |
| 8:00 | 20 | 3 |
| TOTAL | 20 | 3 |

TABLE 4
AVERAGE
Fully Lighted Room

| | | |
|---|---|---|
| Start Irradiance | 434.63 | 431.17 |
| End Irradiance | 433.67 | 426.67 |

| Hour | Catches Black Unit | Catches White Unit |
|---|---|---|
| 0:00 | 0.00 | 0.00 |
| 1:00 | 6.33 | 1.00 |
| 2:00 | 11.33 | 2.00 |
| :00 | 14.00 | 3.00 |
| 4.00 | 16.67 | 3.00 |
| 5 00 | 19.00 | 3.00 |
| 600 | 21.67 | 3.33 |
| 7:00 | 22 67 | 3.33 |
| 8:00 | 22.67 | 3.33 |
| TOTAL | 22.67 | 3.33 |

Tables 5, 6 and 7 show comparable results in a darkened room, and Table 8 shows the average of those test results.

TABLE 5
Dark Room (NO light source other than units)

| | | |
|---|---|---|
| Start Irradiance | 415.00 | 422.40 |
| End Irradiance | 412.20 | 418.05 |

| Hour | Catches Black Unit | Catches White Unit |
|---|---|---|
| 0:00 | 0 | 0 |
| 1:00 | 4 | 5 |
| 2:00 | 7 | 8 |
| 3:00 | 9 | 10 |
| 4:00 | 12 | 13 |
| 5:00 | 13 | 16 |
| 6:00 | 14 | 17 |
| 7:00 | 15 | 17 |
| 8:00 | 15 | 17 |
| TOTAL | 15 | 17 |

TABLE 6
Dark Room (NO light source other than units)

| | | |
|---|---|---|
| Start Irradiance | 432.00 | 449.80 |
| End Irradiance | 421.60 | 445.20 |

| Hour | Catches Black Unit | Catches White Unit |
|---|---|---|
| 0:00 | 0 | 0 |
| 1:00 | 3 | 4 |
| 2:00 | 5 | 7 |
| 3:00 | 7 | 7 |
| 4:00 | 8 | 11 |
| 5:00 | 10 | 12 |
| 6:00 | 12 | 14 |
| 7:00 | 14 | 16 |
| 8:00 | 14 | 18 |
| TOTAL | 14 | 18 |

TABLE 7
Dark Room (NO light source other than units)

| | | |
|---|---|---|
| Start Irradiance | 418.30 | 440.50 |
| End Irradiance | 415.80 | 432.80 |

| Hour | Catches Black Unit | Catches White Unit |
|---|---|---|
| 0:00 | 0 | 0 |
| 1:00 | 3 | 2 |
| 2:00 | 5 | 6 |
| 3:00 | 7 | 8 |
| 4:00 | 8 | 10 |
| 5:00 | 10 | 11 |
| 6:00 | 11 | 12 |
| 7:00 | 11 | 12 |
| 8:00 | 11 | 12 |
| TOTAL | 11 | 12 |

TABLE 8
AVERAGE
Dark Room (NO light source other than units)

| | | |
|---|---|---|
| Start Irradiance | 421.77 | 437.57 |
| End Irradiance | 416.53 | 432.17 |

| Hour | Catches Black Unit | Catches White Unit |
|---|---|---|
| 0:00 | 0.00 | 0.00 |
| 1:00 | 3.33 | 3 67 |
| 2:00 | 5.67 | 7.00 |
| 3:00 | 7.67 | 8.33 |
| 4:00 | 9.33 | 11 33 |
| 5:00 | 11.00 | 13.00 |
| 6:00 | 12.33 | 14.33 |
| 7 00 | 13.33 | 15.00 |
| 8:00 | 13.33 | 15.67 |
| TOTAL | 13.33 | 15.67 |

From the above, it is clearly seen that, in a darkened room there is no significant difference in the average catch, whereas in a fully lighted room, the trap with the black housing captures, on average, seven times as many flies, as the trap with the white housing.

The foregoing descriptions and drawing should be considered as illustrative only of the principles of the invention. As noted, the invention may be configured in a variety of shapes and sizes and is not limited by the dimensions of the preferred embodiment. Numerous applications of the present invention will readily occur to those skilled in the art. Therefore, it is not desired to limit the invention to the preferred embodiments or the exact construction and operation shown and described. Rather, all suitable modifications and equivalents may be resorted to, falling within the scope of the invention.

What is claimed is:

1. In a flying insect trap including a housing defining an interior chamber, an access opening to the chamber for entry of targeted insects, a light within the housing to attract the targeted insects to the access opening, and means within the chamber to trap or kill insects entering the chamber, the improvement which comprises the housing having a exterior surface, and at least portions of said exterior surface surrounding the access opening being substantially black.

2. The improvement of claim 1, wherein the targeted insects are flies

3. The improvement of claim 1, wherein substantially the entire exterior surface of the housing is black.

4. The improvement of claim 1, wherein the means to trap or kill insects entering the chamber comprises an adhesively-coated sheet material carried within the chamber overlying the source of light and juxtaposed to the access opening.

5. The improvement of claim 4, wherein the sheet material is removably received through the access opening.

6. The improvement of claim 4, wherein the sheet material and the adhesive coating transmit light from the source to illuminate the access opening.
